(19) United States
(12) Patent Application Publication
(10) Pub. No.: US 2007/0109947 A1
(43) Pub. Date: May 17, 2007

(54) Optical pickup device

(75) Inventors: Atsushi Ikeda, Osaka (JP); Kenji Nagashima, Osaka (JP); Kazuhiro Takahashi, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/598,081

(22) Filed: Nov. 13, 2006

(30) Foreign Application Priority Data
Nov. 14, 2005 (JP) 2005-328648

(51) Int. Cl. G11B 7/135

(52) U.S. Cl. 369/112.15

(57) ABSTRACT

The optical pickup device (1) includes a two-wavelength compound light source (2) that is capable of emitting two light beams having different wavelengths and a light source (3) emitting a single wavelength light beam. The laser beam emitted from the latter single wavelength light source (3) has an optical path length different from that of the laser beam emitted from the former two-wavelength compound light source (2). The optical pickup device (1) is equipped with a hologram element (8). One of the surfaces (8a) of the hologram element (8) has a lens effect for compensating the difference between the optical path lengths of the laser beams emitted from the single wavelength light source (3) and the two-wavelength compound light source (2). The other surface (8b) of the hologram element (8) has an optical control function for enabling generation of a servo signal.

This application is based on Japanese Patent Application No. 2005-328648 filed on Nov. 14, 2005, the contents of which are hereby incorporated by reference.

### BACKGROUND OF THE INVENTION

1. Field of the Invention

The present invention relates to an optical pickup device that is capable of recording information on an optical recording medium or reading out information recorded on an optical recording medium using a light source emitting light toward a recording surface of the optical recording medium. In particular, the present invention relates to a structure of an optical pickup device including a plurality of light sources having different wavelengths.

2. Description of Related Art

As the optical recording medium, many types of media are available including a compact disc (hereinafter referred to as CD), a digital versatile disk (hereinafter referred to as DVD) and a blue-ray disk (hereinafter referred to as BD) that is recently promoted as a medium having a large storage capacity, and the like. In order to read information recorded on these optical recording media or to write information on these optical recording media, an optical pickup device is used. As the optical pickup device, there is developed a device that is capable of dealing with two types of optical recording media, e.g., a CD and a DVD. Further, an optical pickup device that can deal with three types of optical recording media including a CD, a DVD and a BD is under developing recently.

When the optical pickup device is used for reading information recorded on the optical recording medium for example, a wave aberration such as a spherical aberration, a comatic aberration or astigmatism may be generated resulting in a problem of failure in reading information. In particular, if the optical pickup device is equipped with a plurality of light sources, it is necessary to adjust an optical system of the optical pickup device so that the wave aberration is not generated with respect to each medium.

Therefore, the optical system of the optical pickup device including light sources having different wavelengths may have a structure to be an infinite optical system for a light source having a certain wavelength in which parallel rays enter an objective lens for condensing light from the light source onto the recording surface of the optical recording medium, and to be a finite optical system for other light source having other wavelength in which divergent rays or convergent rays enter the objective lens.

In this case, however, there is an optical path difference between the infinite optical system and the finite optical system. In other words, a distance to a focal point to which return light from the optical recording medium is condensed is different between them. Therefore, the optical pickup device is required to have two or more photo detectors. This causes increase of components, a large size of the optical pickup device and increase of manufacturing cost.

In addition, it is a usual method for the optical pickup device to adjust a focal point of the light beam emitted from the light source onto the recording surface of the optical recording medium continuously and to make the a beam spot position trace a track formed on the optical recording medium by using a servo error signal obtained from the designed optical system. Among such designs, there is a three-beam type optical pickup device as described in JP-A-2005-174452 or JP-A-2000-76688, for example. In this optical pickup device, a diffraction grating is disposed between a light source and an objective lens. A light beam emitted from the light source is divided into three beams by the diffraction grating, and the three light beams are projected to the optical recording medium so that a tracking servo signal is obtained based on light information detected from the reflected light.

However, it is necessary in this three-beam type optical pickup device that each of the three light beams divided by the diffraction grating is adjusted to irradiate the track formed on the optical recording medium with a predetermined relationship. Therefore, if the three-beam type is adapted to the optical pickup device that can emit a plurality of light beams having different wavelengths, a load of adjustment will be increased. In addition, the number of components may be increased because it is necessary to prepare a diffraction grating for each of the light sources.

### SUMMARY OF THE INVENTION

An object of the present invention is to provide an optical pickup device including a plurality of light sources having different wavelengths and different optical path lengths of emitted light beams, which can reduce the number of optical elements with one photo detector and realize simple adjustment of the optical elements.

An optical pickup device according to an aspect of the present invention includes a plurality of light sources having different wavelengths of emitted light beams, a condenser lens for condensing the light beam emitted from the light source onto a recording surface of an optical recording medium, and a photodetector portion for receiving reflected light reflected by the recording surface. When an optical path length of one of the light beams emitted from the plurality of light sources is regarded as a reference optical path length, at least one of the light sources other than the light source having the reference optical path length has an optical path length different from the reference optical path length. A hologram element is disposed between the light source and the condenser lens. One of surfaces of the hologram element including an incident surface of the light beam emitted from the light source and an incident surface of the reflected light has a lens effect for adjusting a distance for the reflected light of the light beam emitted from the light source having an optical path length different from the reference optical path length to be condensed on the photodetector portion to become equal to a distance for the reflected light of the light beam emitted from the light source having the reference optical path length to be condensed on the photodetector portion. The other surface of the hologram element has an optical control function of enabling a generation of a focus servo signal and a tracking servo signal from the reflected light, the focus servo signal being for the condenser lens to adjust its focal point to the recording surface, and the tracking servo signal being for a light spot formed by the condenser lens to follow a track on the optical recording medium.

According to this structure, the optical pickup device including light sources having different optical path lengths can have a single photo detector thanks to the lens effect of the hologram element. In addition, since the other surface of the hologram element opposite to the surface having the lens effect is given the optical control function for controlling the reflected light reflected by the optical recording medium to produce a focus servo signal and a tracking servo signal, it is not necessary to use a diffraction grating or the like for dividing the beam into three beams. Therefore, the number of components can be reduced, and the structure of the optical pickup device can be simplified.

In addition, according to the present invention, in the optical pickup device having the structure described above, the surface of the hologram element having the optical control function is divided into two areas including a first area in which the +1st order diffraction light is focused behind the photodetector portion while the −1st order diffraction light is focused before the photodetector portion and a second area in which the +1st order diffraction light is focused before the photodetector portion while the −1st order diffraction light is focused behind the photodetector portion. Furthermore, the photodetector portion is provided with a light reception area for receiving one of the +1st order light and the −1st order light generated by the diffraction in the first and the second areas so as to generate the focus servo signal, and a light reception area for receiving the other light so as to generate the tracking servo signal.

According to this structure, the focus servo signal can be obtained by a spot size method (SSD method), and the tracking servo signal can be obtained by a correct farfield method (CFF method).

In addition, according to the present invention, the optical pickup device having the structure described above has three of the light sources including a first light source, a second light source, and a third light source in the descending order of the wavelength, the optical path length of the light beam emitted by the first light source is the reference optical path length, the optical path length of the light beam emitted by the second light source is the same as the reference optical path length, and the optical path length of the light beam emitted by the third light source is different from the reference optical path length.

According to this structure, even if the optical pickup device is structured to have an infinite optical system for a BD and a finite optical system for a CD and a DVD for example, a single photo detector is sufficient thanks to the lens effect of the hologram element.

### BRIEF DESCRIPTION OF THE DRAWINGS

FIG. 1 is a diagram showing a general structure of an optical system of an optical pickup device according to an embodiment of the present invention.

FIG. 2A is a schematic diagram showing a position at which reflected light of a laser beam emitted from a two-wavelength compound light source of the optical pickup device of the embodiment is condensed.

FIG. 2B is a schematic diagram showing a position at which reflected light of a laser beam emitted from another light source different from the two-wavelength compound light source of the optical pickup device of the embodiment is condensed.

FIG. 3A is a diagram for explaining an example of a design of a surface having a lens effect of a hologram element.

FIG. 3B is a diagram for explaining an example of the design of a surface having a lens effect of a hologram element.

FIG. 4A is a table showing values that were used in a simulation for designing the surface having a lens effect of a hologram element of the present embodiment.

FIG. 4B is a table showing values that were used in the simulation for designing the surface having a lens effect of a hologram element of the present embodiment.

FIG. 5 is a schematic diagram showing schematically a surface of the hologram element having an optical control function and a light reception area on a photo detector receiving a laser beam that passed through the surface according to the present embodiment.

FIG. 6 is a schematic diagram showing a variation of the optical pickup device of the present embodiment.

### DESCRIPTION OF THE PREFERRED EMBODIMENTS

Now, an embodiment of the present invention will be described with reference to the attached drawings. Note that the embodiment shown here is merely an example, so the present invention is not limited to the embodiment shown here.

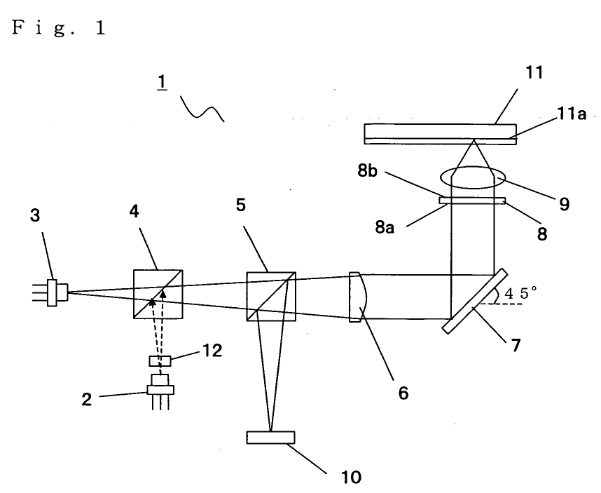

FIG. 1 is a diagram showing a general structure of an optical system of an optical pickup device according to the present embodiment. Numeral 1 is an optical pickup device that is capable of reading information recorded on a recording surface 11a of three types of optical recording media 11 including a CD, a DVD and a BD by projecting a light beam toward the optical recording medium 11 and receiving reflected light. It is also capable of writing information on the recording surface 11a by projecting a light beam toward the optical recording medium 11. This optical pickup device 1 is equipped with a two-wavelength compound light source 2 that is capable of emitting light beams having two different wavelengths, a light source 3 that emits a light beam having a single wavelength, a dichroic prism 4, a beam splitter 5, a collimate lens 6, an upstand mirror 7, a hologram element 8, an objective lens (condenser lens) 9, and a photo detector (photodetector portion) 10. Details of each optical element will be described below.

The two-wavelength compound light source 2 is made up of a monolithic semiconductor laser and has two light emission points for emitting two laser beams including a laser beam having a wavelength of a 780 nm band to support a CD and a laser beam having a wavelength of a 650 nm band to support a DVD. In addition, the light source 3 is a semiconductor laser that is capable of emitting a laser beam of having a single wavelength at a 405 nm band to support a BD. Although a monolithic semiconductor laser is used for the two-wavelength compound light source 2 in the present embodiment, it is not limited to this. For example, a hybrid semiconductor laser may be used, in which light sources manufactured separately are housed in one package.

Furthermore, in the present embodiment, the laser beam emitted from the two-wavelength compound light source 2 is adapted to pass a coaxial correction element 12 as shown in FIG. 1. This coaxial correction element 12 makes it possible to cancel an optical axis shift of the laser beams from the two-wavelength compound light source 2 due to a difference between positions of the two light emission points.

The dichroic prism 4 reflects the laser beam from the two-wavelength compound light source 2 that emits the laser beam for a CD and a DVD, while it allows the laser beam for a BD from the light source 3. The laser beam that was reflected by or passed through the dichroic prism 4 is sent to the beam splitter 5.

The beam splitter 5 works as a dividing element for dividing the laser beams. It allows the laser beam that was reflected by the dichroic prism 4 or has passed through the same to be led to the optical recording medium 11, while it further reflects the reflected light that was reflected by the optical recording medium 11 to be led to the photo detector 10. The laser beam that passed through the beam splitter 5 is sent to the collimate lens 6.

The collimate lens 6 converts the laser beam that was emitted from the light source 3 and passed through the beam splitter 5 into parallel rays. Here, the parallel rays mean light in which all the optical paths of the laser beams emitted from the light source 3 are substantially parallel with the optical axis. On the other hand, since the two-wavelength compound light source 2 is disposed at a position shifted from the focal point of the collimate lens 6, the laser beam that was emitted from the two-wavelength compound light source 2 and passed through the beam splitter 5 becomes not parallel rays but divergent rays. In other words, an optical system of the laser beam emitted from the light source 3 constitutes an infinite optical system, while an optical system of the laser beam emitted from the two-wavelength compound light source 2 constitutes a finite optical system. The laser beam that passed through the collimate lens 6 is sent to the upstand mirror 7.

The upstand mirror 7 reflects the laser beam that passed through the collimate lens 6 and leads the same to the optical recording medium 11. In the present embodiment, the upstand mirror 7 is inclined by 45 degrees as shown in FIG. 1. The laser beam reflected by the upstand mirror 7 is sent to the hologram element 8. The angle of the upstand mirror 7 is not limited to 45 degrees.

The hologram element 8 allows the laser beam reflected by the upstand mirror 7, while it performs a lens effect for a part of the light at a certain wavelength reflected by the optical recording medium 11. It also performs an optical control function of controlling the reflected light so that a servo signal can be obtained for the reflected light at every wavelength. A structure of the hologram element and detailed functions thereof will be described later. The laser beam that passed through the hologram element 8 is sent to the objective lens 9.

The objective lens 9 condenses the laser beam that passed through the hologram element 8 onto the recording surface 11a of the optical recording medium 11. In addition, the objective lens 9 can be moved by an objective lens driving device (not shown) in the vertical direction and the horizontal direction in FIG. 1. The position of the objective lens 9 is controlled based on a focus servo signal and a tracking servo signal that will be described later. Note that the hologram element 8 is structured to move together with this objective lens 9.

The laser beam reflected by the optical recording medium 11 passes through the objective lens 9 and the hologram element 8. Then, it is reflected by the upstand mirror 7 and passes through the collimate lens 6. After that, it is reflected by the beam splitter 5 and is led to the photo detector 10.

The photo detector 10 includes a light reception area that receives zero order light and ±1st order light out of the light diffracted by the optical control function of the hologram element 8. Information of the light received by the photo detector 10 is converted into an electric signal and is supplied to an RF amplifier (not shown) or the like, for example. Then, this electric signal is used as a reproduced signal of data recorded on the recording surface 11a, or a focus servo signal for performing a focus control or a tracking servo signal for performing a tracking control. A detailed structure of the light reception area of the photo detector 10 will be described later.

Next, a structure of the hologram element 8 and detailed functions thereof will be described. Concerning the hologram element 8 of the present invention, a surface 8a of an incidence side of the laser beams emitted from the two-wavelength compound light source 2 and the light source 3 and a surface 8b of an incidence side of the reflected light reflected by the optical recording medium 11 are assigned with different functions, respectively. First, a function of the surface 8a will be described.

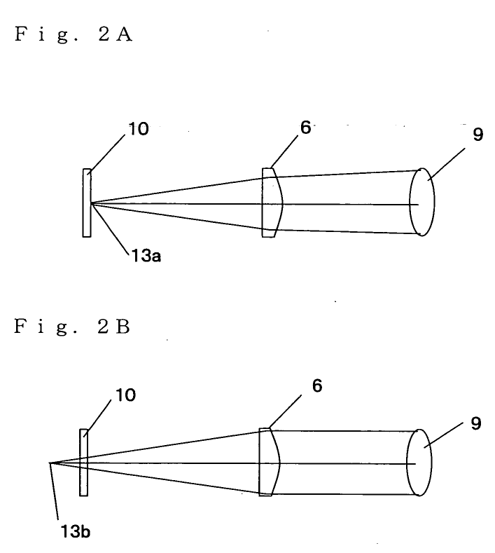

FIGS. 2A and 2B are schematic diagrams for explaining positions at which the light beams reflected by the optical recording medium 11 after emitted from the two-wavelength compound light source 2 and the light source 3 are condensed. Note that FIGS. 2A and 2B show states in the case where the hologram element 8 of the present invention is not disposed. In addition, FIG. 2A shows a position at which the reflected light of the laser beam emitted from the two-wavelength compound light source 2 is condensed, while FIG. 2B shows a position at which the reflected light of the laser beam emitted from the light source 3 is condensed.

As described above, concerning the optical pickup device 1 of the present embodiment, the two-wavelength compound light source 2 constitutes a finite optical system, while the light source 3 constitutes an infinite optical system. Therefore, as shown in FIGS. 2A and 2B, the laser beams emitted from the light sources 2 and 3 propagate different distances until being condensed on the photo detector after reflected by the optical recording medium 11. In the present embodiment, as shown in FIGS. 2A and 2B, a position 13b at which the reflected light of the laser beam emitted from the light source 3 is condensed is farther than a position 13a at which the reflected light of the laser beam emitted from the two-wavelength compound light source 2 is condensed.

If light condensing positions are different as described above, it is necessary to arrange the photo detector 10 separately for each of the two-wavelength compound light source 2 and the light source 3. In contrast, the surface 8a of the hologram element 8 of the present embodiment has the lens effect, so that the light condensing position 13b of the laser beam emitted from the light source 3 is the same as the light condensing position 13a of the laser beam emitted from the two-wavelength compound light source 2. Therefore, the optical pickup device 1 has a single photo detector 10. Next, a design of the surface 8a of the hologram element 8 will be described.

The surface 8a is designed by a simulation using a phase function method that deals with a diffraction surface by defining the number of diffraction gratings or an equivalent of additional optical path length directly as a phase function on a lens surface. In the present embodiment, the surface 8a of the hologram element 8 is designed by using an optical path difference function (a rotational symmetrical polynomial) as shown by the expression (1) below.

Optical path difference function
(R)=(C1×R²+C2×R⁴+C3×R⁶+ . . . ) (1)

Here, C1, C2, C3 . . . denote optical path difference function coefficients (coefficients of the rotational symmetrical polynomial), and R denotes a distance from the optical axis.

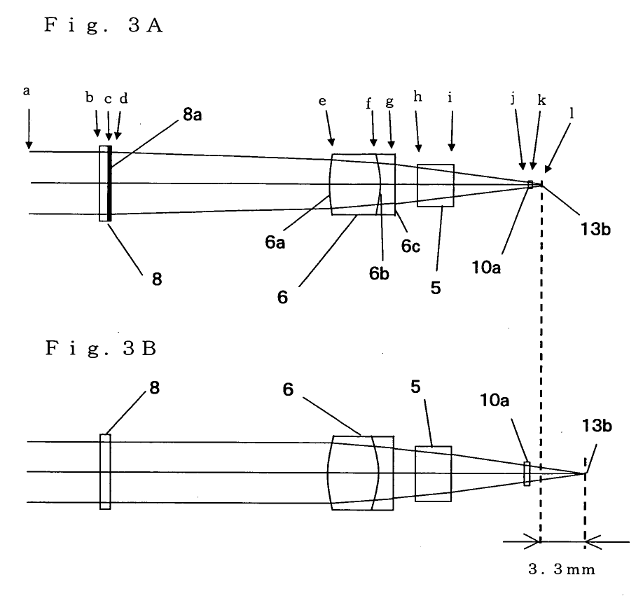

FIGS. 3A and 3B are diagrams for explaining an example of the design of the surface 8a of the hologram element 8. In the present embodiment, the simulation was performed for the case where the laser beam emitted from the light source 3 is condensed 3.3 mm before (in the state of FIG. 3A) when the light condensing position 13b of the laser beam emitted from the light source 3 is 3.3 mm longer than the light condensing position 13a of the laser beam emitted from the two-wavelength compound light source 2 (in the state of FIG. 3B). Note that the surface 8a of the hologram element 8 shown in FIG. 3B is not provided with a lens effect.

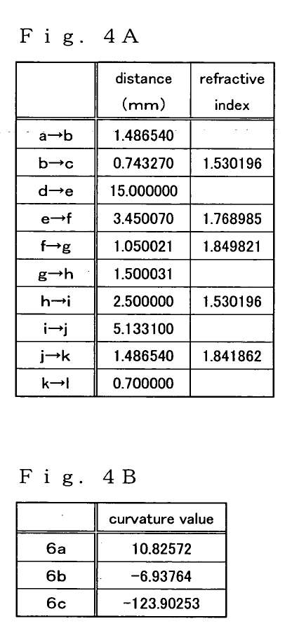

When the simulation is performed, a length (distances) between the positions shown in FIG. 3A by an alphabetic letter, refractive indexes of the collimate lens 6, the beam splitter 5 and the cover glass 10a of the photo detector 10, and curvature values of three lens surfaces 6a-6c of the collimate lens 6 are used as setting conditions. Note that the values used for the simulation are shown as tables in FIGS. 4A and 4B. In addition, when the simulation was performed, the surface denoted by the letter “c” in FIG. 3A is used as the hologram surface.

According to this simulation, a result of the design of the surface 8a of the hologram element 8 in the case where the light condensing position 13b of the laser beam emitted from the light source 3 is disposed 3.3 mm before in the structure of the optical pickup device 1 of the present embodiment is expressed by the optical path difference function below.

Optical path difference function
(R)=(7.3419×10⁻³×R²)−(3.0662×10⁻⁷×R⁴)

By designing in this way, the light that was emitted from the light source 3 and was reflected by the optical recording medium 11 passes through the hologram element 8 to become convergent rays as shown in FIG. 3A. Thus, the light condensing position 13b can be set at the position of 3.3 mm before. Note that the laser beam emitted from the two-wavelength compound light source 2 is designed not to be affected after passing through the surface 8a of the hologram element 8. Therefore, the light condensing position is not changed regardless of presence or absence of the hologram element 8.

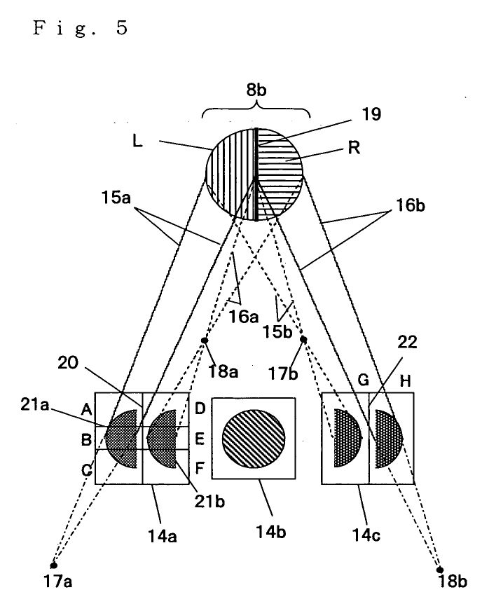

Next, a structure of the surface 8b of the hologram element 8 and a function thereof will be described with reference to FIG. 5. FIG. 5 is a schematic diagram showing schematically the surface 8b of the hologram element 8 and a light reception area of the photo detector 10 (see FIG. 1) that receives the laser beam that passed through the surface 8b. In FIG. 5, rectangular light reception areas 14a-14c are arranged on the photo detector 10. The light reception area 14a receives +1st order diffraction light (+1st order light) 15a and 16a. The light reception area 14b receives zero order diffraction light (zero order light) (not shown). The light reception area 14c receives −1st order diffraction light (−1st order light) 15b and 16b.

As shown in FIG. 5, the surface 8b is divided into two areas L and R. Among the laser beams emitted from the two-wavelength compound light source 2 and the light source 3, the light beams reflected by the recording surface 11a of the optical recording medium 11 (see FIG. 1 for both) are diffracted by the surface 8b having the areas L and R. In the area L, among the diffraction light diffracted here, the +1st order light 15a is adjusted to have a focus position 17a located behind the photo detector 10 while the −1st order light 15b is adjusted to have a focus position 17b located before the photo detector 10. On the other hand, in the area R, among the diffraction light diffracted here, the +1st order light 16a is adjusted to have a focus position 18a before the photo detector 10 while the −1st order light 16b is adjusted to have a focus position 18b located behind the photo detector 10.

Therefore, as shown in FIG. 5, each of the +1st order light beams diffracted by the areas R and L of the surface 8b forms a semicircular spot on the light reception area 14a. On the other hand, each of the −1st order light beams diffracted by the areas R and L of the surface 8b also forms a semicircular spot on the light reception area 14c.

The light reception area 14a is divided into two areas so that the two semicircular light spots are received by the areas respectively, by a line 20 that is parallel with a parting line 19 dividing the surface 8b as shown in FIG. 5. Further, each of the divided areas is divided into three parts by two lines 21a and 21b that are perpendicular to the line 20. Therefore, the light reception area 14a is divided into total six areas (A, B, C, D, E and F). Thus, it is possible to generate a focus error signal by an operation using a so-called spot size method. The focus error signal can be obtained by the operation of (SA+SC−SB)−(SD+SF−SE) using signals SA, SB, SC, SD, SE and SF outputted from the light reception areas A, B, C, D, E and F.

On the other hand, the light reception area 14c is divided into two areas (G, H) so that the two semicircular light spots are received by the areas respectively, by a line 22 that is parallel with a parting line 19 dividing the surface 8b as shown in FIG. 5. Therefore, it is possible to generate a tracking error signal by an operation using a so-called correct farfield method. The tracking error signal is obtained by the operation of SG−SH using signals SG and SH outputted from the light reception areas G and H.

Although an RF signal is obtained by using the zero order light received by the light reception area 14b in the present embodiment, it is possible to obtain it by an operation of SA+SB+SC+SD+SE+SF+SG+SH, for example.

In addition, although the focus error signal and the tracking error signal are respectively obtained from the+1st order light and the −1st order light that are generated by the diffraction on the surface 8b of the hologram element 8 in the present embodiment, it is possible to obtain the focus error signal from the −1st order light and the tracking error signal from the+1st order light.

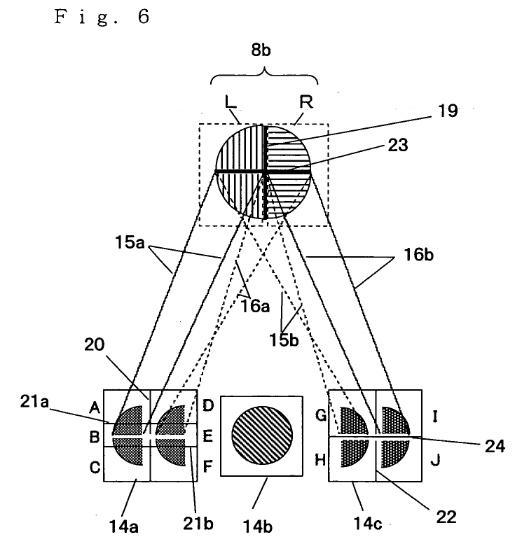

In addition, although the surface 8b of the hologram element 8 is divided into two parts in the present embodiment, the division can be modified in the scope of the present invention. For example, it is possible to divide it into total four parts by further dividing each of the areas R and L of the surface 8b of the present embodiment into two parts by the parting line 23 as shown in FIG. 6 (in this case too, the functions of the areas R and L are the same as the present embodiment). Further in this case, it is possible to structure the light reception area 14c for receiving the −1st order light made up of four areas (G, H, I and J) as shown in FIG. 6. In the case shown in FIG. 6, the focus error signal is obtained by the same operation as the present embodiment, and the tracking error signal is obtained by the operation of (SG+SH)−(SI+SJ). Note that SG, SH, SI and SJ denote signals outputted from the light reception areas S, H, I and J.

In addition, although the surface 8a of the hologram element 8 that is an incident surface of the laser beam emitted from the light sources 2 and 3 has the lens effect while the surface 8b opposed to the surface 8a has the optical control function for generating the focus servo signal and the like in the present embodiment, it is possible to structure so that the functions of the surface 8a and the surface 8b become opposite. Further, although the surface 8b of the hologram element 8 in the present embodiment is designed to obtain the focus error signal by the spot size method and the tracking error signal by the correct farfield method, it is possible to change the design so that the focus error signal is obtained by an astigmatism method, for example.

Other than that, although the optical axis shift that may occur when the two-wavelength compound light source 2 is used is corrected by using the coaxial correction element 12 in the present embodiment, it is possible to add this correction function to the hologram element 8 of the present invention. In addition, although the optical pickup device of the present embodiment emits light beams having three wavelengths for reproducing and recording information on three types of media (CD, DVD and BD), the hologram element of the present invention can be applied to other optical pickup device that emits light beams having two or four or more wavelengths. In the case where the optical pickup device emits light beams having four or more wavelengths, it is possible to structure the hologram element to have the lens effect for light beams having two or more wavelengths.

As described above, according to the present invention, the optical pickup device including light sources having different optical path lengths can have a single photo detector for the lens effect of the hologram element. In addition, since the opposite surface of the hologram element having the lens effect is given the optical control function for controlling the reflected light reflected by the optical recording medium to produce the focus servo signal and the tracking servo signal, it is not necessary to use a diffraction grating or the like for dividing the beam into three beams. Thus, the number of components can be reduced, and the structure of the optical pickup device can be simplified.

In addition, since the spot size method is used for obtaining the focus servo signal and the correct farfield method for obtaining the tracking servo signal, the optical pickup device of the present invention can be used for reproducing and recording information correctly.

What is claimed is:

1. An optical pickup device comprising:
a plurality of light sources having different wavelengths of emitted light beams;
a condenser lens for condensing the light beam emitted from the light source onto a recording surface of an optical recording medium;
a photodetector portion for receiving reflected light reflected by the recording surface; and
a hologram element disposed between the light source and the condenser lens, wherein
when an optical path length of one of the light beams emitted from the plurality of light sources is regarded as a reference optical path length, at least one of the light sources other than the light source having the reference optical path length has an optical path length different from the reference optical path length,
one of surfaces of the hologram element including an incident surface of the light beam emitted from the light source and an incident surface of the reflected light has a lens effect for adjusting a distance for the reflected light of the light beam emitted from the light source having an optical path length different from the reference optical path length to be condensed on the photodetector portion to become equal to a distance for the reflected light of the light beam emitted from the light source having the reference optical path length to be condensed on the photodetector portion, and
the other surface of the hologram element has an optical control function of enabling a generation of a focus servo signal and a tracking servo signal from the reflected light, the focus servo signal being for the condenser lens to adjust its focal point to the recording surface, and the tracking servo signal being for a light spot formed by the condenser lens to follow a track on the optical recording medium.

2. The optical pickup device according to claim 1, wherein
the surface of the hologram element having the optical control function is divided into two areas including a first area in which the+1st order diffraction light is focused behind the photodetector portion while the −1st order diffraction light is focused before the photodetector portion and a second area in which the +1st order diffraction light is focused before the photodetector portion while the −1st order diffraction light is focused behind the photodetector portion, and the photodetector portion is provided with a light reception area for receiving one of the+1st order light and the −1st order light generated by the diffraction in the first and the second areas so as to generate the focus servo signal, and a light reception area for receiving the other light so as to generate the tracking servo signal.

3. The optical pickup device according to claim 1, wherein
three of the light sources are provided including a first light source, a second light source, and a third light source in the descending order of the wavelength, the optical path length of the light beam emitted by the first light source is the reference optical path length, the optical path length of the light beam emitted by the second light source is the same as the reference optical path length, and the optical path length of the light beam emitted by the third light source is different from the reference optical path length.

4. The optical pickup device according to claim 2, wherein
three of the light sources are provided including a first light source, a second light source, and a third light source in the descending order of the wavelength, the optical path length of the light beam emitted by the first light source is the reference optical path length, the optical path length of the light beam emitted by the second light source is the same as the reference optical path length, and the optical path length of the light beam emitted by the third light source is different from the reference optical path length.
